(19) United States
(12) Patent Application Publication
(10) Pub. No.: US 2017/0046581 A1
(43) Pub. Date: Feb. 16, 2017

(54) Sending Navigational Feature Information

(71) Applicant: HERE Global B.V., LB Veldhoven (NL)

(72) Inventor: John RISTEVSKI, Oakland, CA (US)

(21) Appl. No.: 14/824,072

(22) Filed: Aug. 11, 2015

(51) Int. Cl. G06K 9/00; G01C 21/20; H04N 5/44; B60R 1/00; B60R 11/04; G01C 21/26; H04N 7/18

(52) U.S. Cl. CPC G06K 9/00818; G01C 21/265; G01C 21/20; H04N 7/18; B60R 1/00; B60R 11/04; H04N 5/44; G06K 9/00476

(57) ABSTRACT

A method comprising capturing at least one image by way of the camera module, identifying at least one navigational feature that is represented in the image, and sending, by way of the communication device, information indicative of the navigational feature to a map data repository is disclosed.

### TECHNICAL FIELD

The present application relates generally to sending navigational feature information.

### BACKGROUND

Users are becoming increasingly dependent upon map data in the performance of various activities in their daily lives. For example, many users rely on map data for navigation, for locating particular places or activities, etc. Such dependency has resulted in an increasing dependency upon the accuracy of the map data that the users rely upon. Therefore, it is increasingly important for map data to be updated appropriately.

### SUMMARY

Various aspects of example embodiments are set out in the summary, the drawings, the detailed description, and the claims.

One or more example embodiments may provide an apparatus that comprises a housing, at least one processor that is contained within the housing, at least one camera module that is contained within the housing and configured to interact with the at least one processor, the housing comprising at least one aperture through which the camera module is configured to capture visual information, at least one communication device that is contained within the housing and configured to interact with the at least one processor, and at least one memory that includes computer program code comprising instructions for execution by the at least one processor.

One or more example embodiments may provide an apparatus, a computer readable medium, a non-transitory computer readable medium, a computer program product, and/or a method for capturing at least one image by way of a camera module, identifying at least one navigational feature that is represented in the image, and sending, by way of a communication device, information indicative of the navigational feature to a map data repository.

One or more example embodiments may provide an apparatus, a computer readable medium, a computer program product, and/or a non-transitory computer readable medium having means for capturing at least one image by way of a camera module, means for identifying at least one navigational feature that is represented in the image, and means for sending, by way of a communication device, information indicative of the navigational feature to a map data repository.

In at least one example embodiment, the housing comprises at least one magnet that is configured to affix the housing to an automobile.

In at least one example embodiment, an outer surface of the housing is water resistant.

In at least one example embodiment, the housing has a volume that is less than or substantially equal to 1.125 cubic feet.

In at least one example embodiment, the housing has a volume that is less than or substantially equal to 0.5 cubic feet.

In at least one example embodiment, the housing has a volume that is less than or substantially equal to 0.23 cubic feet.

One or more example embodiments further includes a power cable that extends outward from the housing and is configured to connect to an electrical outlet of a vehicle.

In at least one example embodiment, the apparatus fails to comprise any output device.

In at least one example embodiment, the apparatus comprises a single output device that indicates operational status of the apparatus.

In at least one example embodiment, the apparatus fails to comprise any output device other than the single output device.

In at least one example embodiment, the apparatus fails to comprise any user input device.

In at least one example embodiment, the apparatus comprises a single user input device that selectively initiates or terminates operation of the apparatus.

In at least one example embodiment, the apparatus fails to comprise any input device other than the single input device.

In at least one example embodiment, the computer program code fails to comprise instructions that require a user input.

In at least one example embodiment, the computer program code fails to comprise any instructions that predicate any action upon any user input.

In at least one example embodiment, the computer program code comprises instructions that cause the apparatus to operate absent any user input.

One or more example embodiments further deletes the image subsequent to the identification of the navigational feature.

One or more example embodiments further deletes the image prior to the sending of the information indicative of the navigational feature.

One or more example embodiments further deletes the image prior to capturing any other image.

In at least one example embodiment, the at least one memory comprises volatile memory and nonvolatile memory.

One or more example embodiments further stores the image in the volatile memory.

One or more example embodiments further avoids storage of the image in nonvolatile memory.

In at least one example embodiment, the identification of the navigational feature comprises identifying a portion of the image to be a representation of a predetermined type of navigational demarcation, and the navigational feature comprises information indicative of the predetermined type of navigational demarcation.

In at least one example embodiment, the navigational demarcation signifies at least one of a road sign, a lane marker, or a traffic signal.

In at least one example embodiment, the identification of the navigational feature comprises identifying a portion of the image to be a representation of a road sign, recognizing a subportion of the portion of the image to be a representation of road sign information, and performing pattern recognition on the subportion to determine road sign conveyance data.

In at least one example embodiment, the navigational feature comprises information indicative of the navigational feature being a road sign.

In at least one example embodiment, the navigational feature comprises information indicative of the road sign conveyance data.

One or more example embodiments further determines an apparatus location, determines a navigational feature location based, at least in part, on the apparatus location and the image, and sends, by way of the communication device, information indicative of the navigational feature location to the map data repository.

One or more example embodiments further determines that map data fails to accurately represent the navigational feature, wherein the sending of the information indicative of the navigational feature is performed in response to the determination that the map data fails to accurately represent the navigational feature.

In at least one example embodiment, the determination that the map data fails to accurately represent the navigational feature comprises determination that the navigational feature is absent from the map data.

In at least one example embodiment, the determination that the map data fails to accurately represent the navigational feature comprises determination that the navigational feature is indicated by the map data and that the navigation feature location differs from a navigational feature location indicated by the map data.

In at least one example embodiment, the determination that the map data fails to accurately represent the navigational feature comprises determination that the navigational feature and the navigational feature location correspond with the map data, and that supplemental map data associated with the navigational feature differs from supplemental map data that is indicated by the map data.

In at least one example embodiment, the map data is stored in nonvolatile memory comprised by the apparatus.

One or more example embodiments further receives the map data from the map data repository.

One or more example embodiments further identifies at least one other navigational feature that is represented in the image, and determines another navigational feature location based, at least in part, on the apparatus location and the image, the other navigational feature location being a location of the other navigational feature.

One or more example embodiments further determines that the map data accurately represents the other navigational feature, and precludes sending, to the map data repository, information indicative of the other navigational feature based, at least in part, on the determination that the map data accurately represents the other navigational feature.

One or more example embodiments further determines an enhanced apparatus location based, at least in part, on the apparatus location, the navigational feature location, and a navigational feature location indicated by the map data.

In at least one example embodiment, the determination of the enhanced apparatus location is performed in response to the determination that the map data accurately represents the other navigational feature.

In at least one example embodiment, the enhanced apparatus location has a greater precision than the apparatus location.

### BRIEF DESCRIPTION OF THE DRAWINGS

For a more complete understanding of one or more example embodiments, reference is now made to the following descriptions taken in connection with the accompanying drawings in which:

FIG. 1 is a block diagram showing an apparatus according to at least one example embodiment;

FIG. 2 is a diagram illustrating apparatus communication according to at least one example embodiment;

FIGS. 3A-3C are diagrams illustrating a map data capture apparatus according to at least one example embodiment;

FIGS. 4A-4B are diagrams illustrating a host vehicle sensor apparatus according to at least one example embodiment;

FIG. 5 is a diagram illustrating representations of navigational features according to at least one example embodiment;

FIG. 6 is a flow diagram illustrating activities associated with identification of a navigational feature according to at least one example embodiment;

FIG. 7 is a flow diagram illustrating activities associated with identification of a navigational feature according to at least one example embodiment;

FIG. 8 is a flow diagram illustrating activities associated with identification of a navigational feature according to at least one example embodiment;

FIG. 9 is a flow diagram illustrating activities associated with identification of a navigational feature according to at least one example embodiment; and

FIG. 10 is a flow diagram illustrating activities associated with identification of a navigational feature according to at least one example embodiment

### DETAILED DESCRIPTION OF THE DRAWINGS

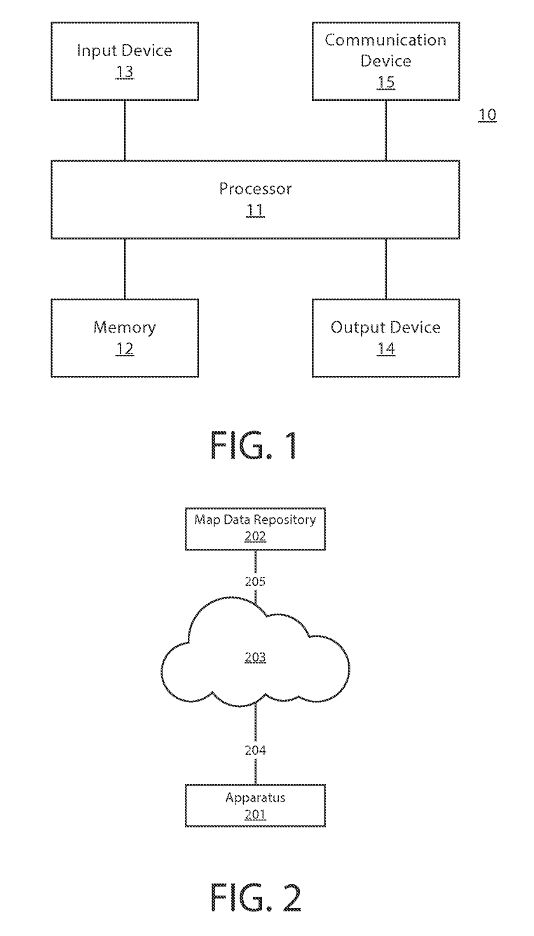

Various example embodiments and some of their potential advantages are understood by referring to FIGS. 1 through 10 of the drawings.

Some example embodiments will now further be described hereinafter with reference to the accompanying drawings, in which some, but not all, example embodiments are shown. One or more example embodiments may be embodied in many different forms and the claims should not be construed as being strictly limited to the example embodiments set forth herein; rather, these example embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with one or more example embodiments. Thus, use of any such terms should not be taken to limit the spirit and scope of example embodiments.

Additionally, as used herein, the term ‘circuitry’ refers to (a) hardware-only circuit implementations (e.g., implementations in analog circuitry, digital circuitry and/or any combination thereof); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that utilize software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit, an applications processor integrated circuit, a cellular network apparatus, other network apparatus, and/or other computing apparatus.

As defined herein, a “non-transitory computer readable medium,” which refers to a physical medium (e.g., volatile or non-volatile memory device), can be differentiated from a “transitory computer-readable medium,” which refers to an electromagnetic signal. In at least one example embodiment, a non-transitory computer readable medium is a tangible non-transitory computer readable medium.

FIG. 1 is a block diagram showing an apparatus 10, such as an electronic apparatus, according to at least one example embodiment. It should be understood, however, that an electronic apparatus as illustrated and hereinafter described is merely illustrative of an electronic apparatus that could benefit from one or more example embodiments and, therefore, should not be taken to limit the scope of the claims. While apparatus 10 is illustrated and will be hereinafter described for purposes of example, other types of electronic apparatuses may readily employ one or more example embodiments. Apparatus 10 may be a personal digital assistant (PDAs), a pager, a mobile computer, a laptop computer, a tablet computer, a media player, a mobile phone, a global positioning system (GPS) apparatus, and/or any other type of electronic system. Moreover, the apparatus of at least one example embodiment need not be the entire electronic apparatus, but may be a component or group of components of the electronic apparatus in other example embodiments. For example, the apparatus may be an integrated circuit, a set of integrated circuits, and/or the like.

Furthermore, apparatuses may readily employ one or more example embodiments regardless of any intent to provide mobility. In this regard, even though some example embodiments may be described in conjunction with mobile applications, it should be understood that such example embodiments may be utilized in conjunction with a variety of other applications, both in the mobile communications industries and outside of the mobile communications industries.

In at least one example embodiment, apparatus 10 comprises at least one processor, such as processor 11 and at least one memory, such as memory 12. Processor 11 may be any type of processor, controller, embedded controller, processor core, and/or the like. In at least one example embodiment, processor 11 utilizes computer program code to cause an apparatus to perform one or more actions. Memory 12 may comprise volatile memory, such as volatile Random Access Memory (RAM) including a cache area for the temporary storage of data and/or other memory, for example, non-volatile memory, which may be embedded and/or may be removable. The non-volatile memory may comprise an EEPROM, flash memory and/or the like. Memory 12 may store any of a number of pieces of information, and data. The information and data may be used by apparatus 10 to implement one or more functions of apparatus 10, such as the functions described herein. In at least one example embodiment, memory 12 includes computer program code such that the memory and the computer program code are configured to, working with the processor, cause the apparatus to perform one or more actions described herein.

Apparatus 10 may be configured so that processor 11 may control various elements of apparatus 10, may transfer information to and/or from various elements of apparatus 10, and/or the like. In this manner, processor 11 may be communicatively coupled with input device 13, communication device 15, memory 12, output device 14, and/or the like.

Apparatus 10 may further comprise a communication device 15. In at least one example embodiment, communication device 15 comprises an antenna, (or multiple antennae), a wired connector, and/or the like in operable communication with a transmitter and/or a receiver. In at least one example embodiment, processor 11 provides signals to a transmitter and/or receives signals from a receiver. The signals may comprise signaling information in accordance with a communications interface standard, user speech, received data, user generated data, and/or the like. Communication device 15 may operate with one or more air interface standards, communication protocols, modulation types, and access types (e.g., one or more standards in the Institute of Electrical and Electronics Engineers (IEEE) 802 family of wired and wireless standards). By way of illustration, the electronic communication device 15 may operate in accordance with second-generation (2G) wireless communication protocols IS-136 (time division multiple access (TDMA)), Global System for Mobile communications (GSM), and IS-95 (code division multiple access (CDMA)), with third-generation (3G) wireless communication protocols, such as Universal Mobile Telecommunications System (UMTS), CDMA2000, wideband CDMA (WCDMA) and time division-synchronous CDMA (TD-SCDMA), and/or with fourth-generation (4G) wireless communication protocols, wireless networking protocols, such as 802.11, short-range wireless protocols, such as Bluetooth, and/or the like. Communication device 15 may operate in accordance with wireline protocols, such as Ethernet, digital subscriber line (DSL), asynchronous transfer mode (ATM), and/or the like.

Processor 11 may comprise means, such as circuitry, for implementing audio, video, communication, navigation, logic functions, and/or the like, as well as for implementing one or more example embodiments including, for example, one or more of the functions described herein. For example, processor 11 may comprise means, such as a digital signal processor device, a microprocessor device, an analog to digital converter, a digital to analog converter, processing circuitry and other circuits, for performing various functions including, for example, one or more of the functions described herein. The apparatus may perform control and signal processing functions of the electronic apparatus 10 among these devices according to their respective capabilities. The processor 11 thus may comprise the functionality to encode and interleave message and data prior to modulation and transmission. The processor 11 may additionally comprise an internal voice coder, and may comprise an internal data modem. Further, the processor 11 may comprise functionality to operate one or more software programs, which may be stored in memory and which may, among other things, cause the processor 11 to implement at least one embodiment including, for example, one or more of the functions described herein. For example, the processor 11 may operate a connectivity program, such as a conventional internet browser. The connectivity program may allow the electronic apparatus 10 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

Apparatus 10 may comprise a user interface for providing output and/or receiving input. Apparatus 10 may comprise an output device 14. Output device 14 may comprise an audio output device, such as a ringer, an earphone, a speaker, and/or the like. Output device 14 may comprise a tactile output device, such as a vibration transducer, an electronically deformable surface, an electronically deformable structure, and/or the like. Output device 14 may comprise a visual output device, such as a display, a light, and/or the like. In at least one example embodiment, the apparatus causes display of information. The causation of display may comprise displaying the information on a display comprised by the apparatus, sending the information to a separate apparatus, and/or the like. For example, the apparatus may send the information to a separate display, to a computer, to a laptop, to a mobile apparatus, and/or the like. For example, the apparatus may be a server that causes display of the information by way of sending the information to a client apparatus that displays the information. In this manner, causation of display of the information may comprise sending one or more messages to the separate apparatus that comprise the information, streaming the information to the separate apparatus, and/or the like. The electronic apparatus may comprise an input device 13. Input device 13 may comprise a light sensor, a proximity sensor, a microphone, a touch sensor, a force sensor, a button, a keypad, a motion sensor, a magnetic field sensor, a camera, and/or the like. A touch sensor and a display may be characterized as a touch display. In an embodiment comprising a touch display, the touch display may be configured to receive input from a single point of contact, multiple points of contact, and/or the like. In such an embodiment, the touch display and/or the processor may determine input based, at least in part, on position, motion, speed, contact area, and/or the like. In at least one example embodiment, the apparatus receives an indication of an input. The apparatus may receive the indication from a sensor, a driver, a separate apparatus, and/or the like. The information indicative of the input may comprise information that conveys information indicative of the input, indicative of an aspect of the input indicative of occurrence of the input, and/or the like.

Apparatus 10 may include any of a variety of touch displays including those that are configured to enable touch recognition by any of resistive, capacitive, infrared, strain gauge, surface wave, optical imaging, dispersive signal technology, acoustic pulse recognition, or other techniques, and to then provide signals indicative of the location and other parameters associated with the touch. Additionally, the touch display may be configured to receive an indication of an input in the form of a touch event which may be defined as an actual physical contact between a selection object (e.g., a finger, stylus, pen, pencil, or other pointing device) and the touch display. Alternatively, a touch event may be defined as bringing the selection object in proximity to the touch display, hovering over a displayed object or approaching an object within a predefined distance, even though physical contact is not made with the touch display. As such, a touch input may comprise any input that is detected by a touch display including touch events that involve actual physical contact and touch events that do not involve physical contact but that are otherwise detected by the touch display, such as a result of the proximity of the selection object to the touch display. A touch display may be capable of receiving information associated with force applied to the touch screen in relation to the touch input. For example, the touch screen may differentiate between a heavy press touch input and a light press touch input. In at least one example embodiment, a display may display two-dimensional information, three-dimensional information and/or the like.

In example embodiments including a keypad, the keypad may comprise numeric (for example, 0-9) keys, symbol keys (for example, #, *), alphabetic keys, and/or the like for operating apparatus 10. For example, the keypad may comprise a conventional QWERTY keypad arrangement. The keypad may also comprise various soft keys with associated functions. In addition, or alternatively, apparatus 10 may comprise an interface device such as a joystick or other user input interface.

Input device 13 may comprise a media capturing element. The media capturing element may be any means for capturing an image, video, and/or audio for storage, display, or transmission. For example, in at least one example embodiment in which the media capturing element is a camera module, the camera module may comprise a digital camera which may form a digital image file from a captured image. As such, the camera module may comprise hardware, such as a lens or other optical component(s), and/or software for creating a digital image file from a captured image. Alternatively, the camera module may comprise only the hardware for viewing an image, while a memory device of the electronic apparatus 10 stores instructions for execution by the processor 11 in the form of software for creating a digital image file from a captured image. In at least one example embodiment, the camera module may further comprise a processing element that is separate from processor 11 for processing data, such as image data. The camera module may provide data, such as image data, in one or more of various formats. In at least one example embodiment, the camera module comprises an encoder, a decoder, and/or the like for compressing and/or decompressing image data. The encoder and/or decoder may encode and/or decode according to a standard format, for example, a Joint Photographic Experts Group (JPEG) standard format.

It should be understood that, even though the example of FIG. 1 illustrates various elements as being separate, various elements may be combined into a single part. For example, a single integrated circuit may comprise one or more processors, at least a portion of the apparatus memory, at least a portion of at least one apparatus input device, at least a portion of at least one output device, at least a portion of at least one communication device, and or the like.

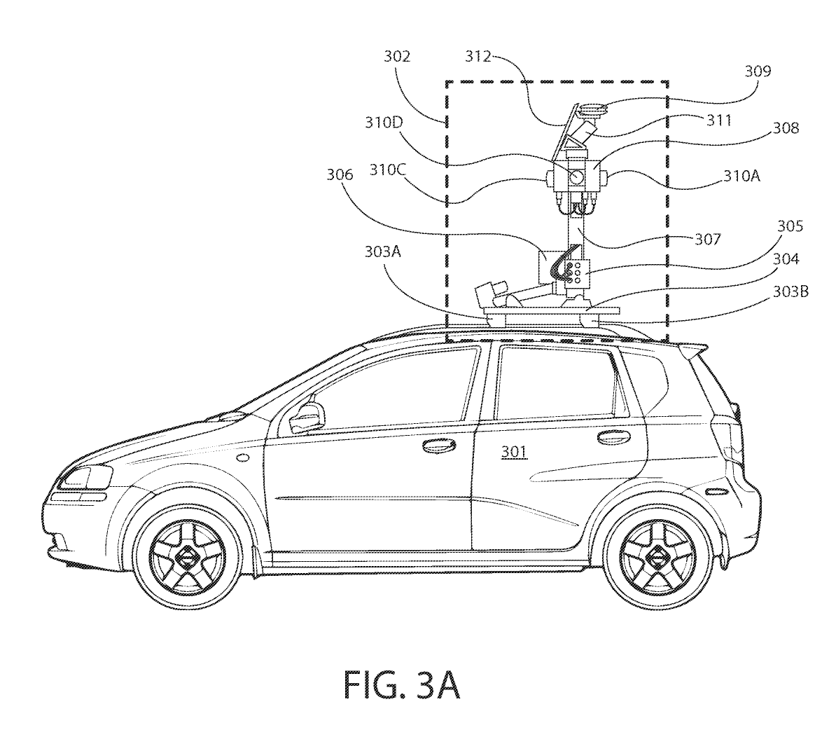

FIG. 2 is a diagram illustrating apparatus communication according to at least one example embodiment. The example of FIG. 2 is merely an example and does not necessarily limit the scope of the claims. For example, apparatus count may vary, apparatus configuration may vary, communication channels may vary, and/or the like.

In modern times, vehicles may utilize one or more sensors to navigate autonomously. For example, an automobile, an aircraft, a watercraft, an agricultural implement, and/or the like may utilize a satellite navigation system such as a Global Positioning System (GPS) receiver, a GLONASS receiver, a Galileo receiver, and/or the like to determine the vehicle's location on the Earth and navigate to a different location without real time control input from an operator of the vehicle. In at least one example embodiment, an apparatus determines a location of the apparatus based on sensor information. For example, the apparatus may determine a location that is a set of geographic coordinates, an address, an intersection of two streets, and/or the like. In at least one example embodiment, an apparatus receives sensor information from at least one sensor. Sensor information may refer to raw data, formatted data, processed data, and/or the like received from a sensor. For example, a GPS receiver may transmit data packets to an apparatus having a particular format, a radar sensor may transmit analog voltages to the apparatus, a camera module may transmit visual information, such as an image, and/or the like.

One or more example embodiments may utilize a geographic database. For example, the geographic database may comprise, navigational data, location attributes, and/or the like. Information included within a geographic database may be referred to as map data. For example, the geographic database may include node data records, road segment or link data records, point of interest (POI) data records, perspective image data records, video content data records, and other data records. In at least one example embodiment, map data includes at least one of road segment data, POI data, node data, traffic information, or weather information. More, fewer or different data records may be provided. In at least one example embodiment, the other data records include cartographic (“carto”) data records, routing data, and maneuver data. One or more portions, components, areas, layers, features, text, and/or symbols of the POI or event data may be stored in, linked to, and/or associated with one or more of these data records. For example, one or more portions of the POI, event data, or recorded route information may be matched with respective map or geographic records via position or GPS data associations (such as using known or future map matching or geo-coding techniques), for example.

In at least one example embodiment, the road segment data records are links or segments representing roads, streets, or paths, as may be used in the calculated route or recorded route information for determination of one or more personalized routes. The node data records may be end points corresponding to the respective links or segments of the road segment data records. The road link data records and the node data records may represent a road network, such as used by vehicles, cars, and/or other entities. Alternatively, the geographic database may contain path segment and node data records or other data that represent pedestrian paths or areas in addition to or instead of the vehicle road record data, for example.

The road/link segments and nodes, as well as other geographic locations may be associated with attributes, such as geographic coordinates, road surface conditions, traffic conditions, adjacent geographic features, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database may include data about the POIs and their respective locations in the POI data records. The geographic database may also include data about places, such as cities, towns, or other communities, and other geographic features, such as bodies of water, mountain ranges, etc. Such place or feature data may be part of the POI data or may be associated with POIs or POI data records (such as a data point used for displaying or representing a position of a city). In addition, the geographic database may include and/or be associated with event data (e.g., traffic incidents, constructions, scheduled events, unscheduled events, etc.) associated with the POI data records or other records of the geographic database.

The geographic database may be maintained by a content provider (e.g., a map developer) in association with a services platform. By way of example, the map developer may collect geographic data to generate the geographic database, enhance the geographic database, update the geographic database, and/or the like. There may be many different ways utilized by the map developer to collect data. These ways may include obtaining data from other sources, such as municipalities or respective geographic authorities. In addition, for example, the map developer may employ field personnel to travel by vehicle along roads throughout the geographic region to observe features and/or record information about them. Also, remote sensing, such as aerial or satellite photography, may be used.

The geographic database may be a master geographic database stored in a format that facilitates updating, maintenance, and development. For example, the master geographic database or data in the master geographic database may be in an Oracle spatial format or other spatial format, such as for development or production purposes. The Oracle spatial format or development/production database may be compiled into a delivery format, such as a geographic data files (GDF) format. The data in the production and/or delivery formats may be compiled or further compiled to form geographic database products or databases, which may be used in end user navigation apparatuses or systems.

Geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation apparatus, such as by an end user apparatus, for example. The navigation-related functions may correspond to vehicle navigation, pedestrian navigation, or other types of navigation. The compilation to produce the end user databases may be performed by a party or entity separate from the map developer. For example, a customer of the map developer, such as a navigation apparatus developer or other end user apparatus developer, may perform compilation on a received geographic database in a delivery format to produce one or more compiled navigation databases.

In some circumstances, the geographic data compiled within a database may be static data. For example, the geographic data may be values that rarely or never change, such as the latitude and longitude of an address, the relative positions of roads, and/or the like. Such data may be referred to as static map data. In some circumstances, the geographic data compiled within a database may be dynamic data. For example, the geographic data may be values that change frequently over time, such as traffic conditions, weather conditions, and/or the like. Such data may be referred to as dynamic map data.

As mentioned above, a server side geographic database may be a master geographic database, but in alternate embodiments, a client side geographic database may represent a compiled navigation database that may be used in or with an end user apparatus to provide navigation and/or map-related functions. For example, the geographic database may be used with an end user apparatus to provide an end user with navigation features. In such an example, the geographic database may be downloaded or stored on the end user apparatus, such as in one or more applications, or the end user apparatus may access the geographic database through a wireless or wired connection (such as via a server and/or a communication network), for example.

Map data that is associated with the location of the apparatus may refer to map data that has a data association with the location of the apparatus. For example, an apparatus may receive GPS signals corresponding with latitude and longitude coordinates, and the apparatus may receive map data associated with the coordinates from a geographical database. In some circumstances, map data may be stored in memory. For example, a navigational apparatus may comprise non-volatile memory, a hard disk drive, and/or the like to store a geographical database. In at least one example embodiment, receiving the map data comprises retrieving the map data from memory. In some circumstances, map data may be stored on a separate apparatus, such as a map data repository. For example, the map data repository may be a server hosted by a service provider, stored in the memory of a separate apparatus such as an automobile, and/or the like. In at least one example embodiment, receiving the map data comprises retrieving the map data from a separate apparatus, such as a map data repository.

In at least one example embodiment, an apparatus receives map data that is associated with a location of the apparatus. For example, the apparatus may receive map data from a map data repository. In at least one example embodiment, the map data repository is an apparatus that allows one or more separate apparatus to utilize at least a portion of a geographic database that is accessible by the map data repository. For example, an apparatus may retrieve map data from the map data repository. In such an example, the apparatus may update and/or supplement a geographic database that is stored in memory of the apparatus by way of retrieving map data from the map data repository. In such an example, the map data repository may send a portion of the map data that is included in the geographic databased that is accessible by the map data repository.

In addition to circumstances where a map data repository provides map data to an apparatus, there are circumstances where an apparatus sends map data to a map data repository. In at least one example embodiment, the apparatus provides map data to the map data repository. For example, the apparatus may acquire information that may be utilized for updating, supplementing, removing, adding, etc., map data within the geographic database of the map data repository. In this manner, the apparatus may cause modification of the geographical database of the map data repository by sending such information to the map data repository.

In some circumstances, a user may desire to have collaboration between apparatuses, such as between an apparatus and a separate apparatus. In at least one example embodiment, apparatuses communicate with each other, for example, by way of one or more communication devices, such as communication device 15 of FIG. 1. For example, an apparatus may be an apparatus that automatically communicates with another apparatus for purposes such as identifying the apparatus, synchronizing data, exchanging status information, and/or the like. In at least one example embodiment, an apparatus retains information associated with communication with a separate apparatus. For example, the apparatus may comprise information associated with identifying, communicating with, authenticating, performing authentication with, and/or the like, the separate apparatus. In this manner, the apparatus may be privileged to perform operations in conjunction with the separate apparatus that a different apparatus may lack the privilege to perform. For example, the apparatus may be privileged to access specific information that may be stored on the separate apparatus, cause the apparatus to perform one or more operations in response to a directive communicated to the separate apparatus, and/or the like.

In the example of FIG. 2, apparatus 201 communicates with map data repository 202 by way of communication channel 204, network 203, and communication channel 205. For example, apparatus 201 may send information to map data repository 202 by way of communication channel 204, network 203, and communication channel 205. Similarly, apparatus 202 may receive information sent from map data repository 202 by way of communication channel 204, network 203, and communication channel 205. It should be understood that communication channel 204, network 203, and communication channel 205 of the example of FIG. 2 illustrates an indirect communication channel between apparatus 201 and map data repository 202. However, the manner of communication between apparatus 201 and map data repository 202 may vary. For example, apparatus 201 may communicate directly with map data repository, absent communication through any network.

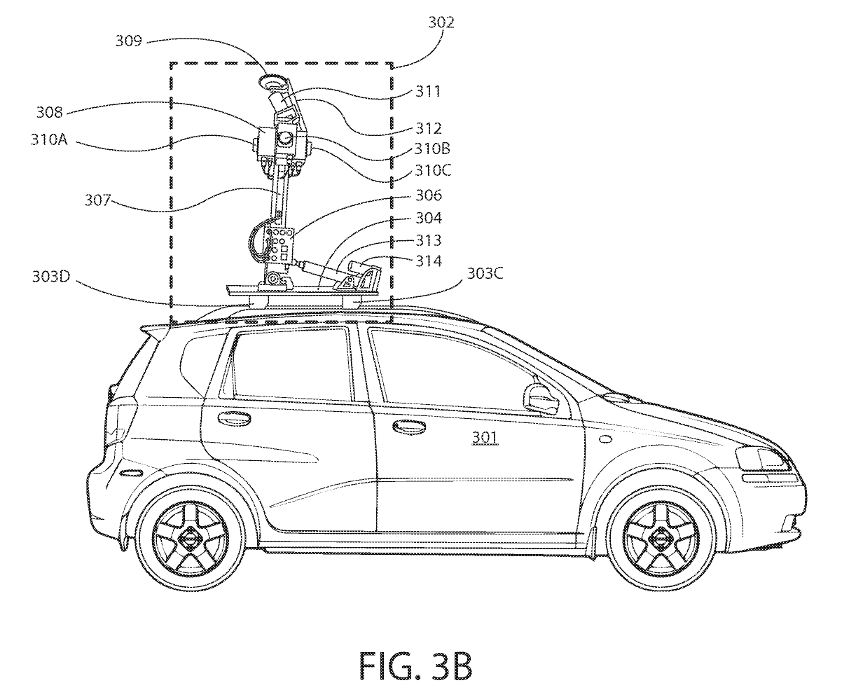

FIGS. 3A-3C are diagrams illustrating a map data capture apparatus according to at least one example embodiment. The example of FIGS. 3A-3C are merely examples and do not necessarily limit the scope of the claims. For example, configuration of the map data capture apparatus may vary, devices comprised by the map data capture apparatus may vary, position of devices comprised by the map data capture apparatus may vary, and/or the like.

As previously described, an apparatus may utilize map data from a geographic database. As this technology has become more widely available, users have become increasingly dependent upon map data for performing important activities in their everyday lives. For example, even non-technical users rely heavily on navigation apparatuses for viewing maps, providing navigational instructions, determining routes, avoiding traffic, etc. In another example, many businesses rely on map data for distribution route planning, development planning, as well as viewing maps, providing navigational instructions, determining routes, avoiding traffic, etc. This increased reliance is predicated upon the accuracy of the map data. For example, if a user relies heavily upon a navigational apparatus to find a gas station, the user may be stranded if the user runs out of gas due to being directed on a highly inefficient route, being directed to a store that is no longer the desired gas station, being directed to utilize a road segment that is not current navigable, etc. Therefore, for map data to be able to properly fulfill this high level of user expectation, it is critical for the map data provider to take measures to, not only initially obtain the map data, but to continually update the map data.

However, updating map data may be a difficult task. For example, many roads change due to construction, replanning, disasters, etc. In another example, many new roads are being added, and many existing roads are being removed. Furthermore, many existing roads are undergoing changes. For example, a road may change number of lanes, speed limit, traffic control measures, etc. To illustrate this point, between 2011 and 2012, 80 percent of the road network of New Delhi, India was modified in some way. Such a rate of change can catastrophically compromise the usability of the map data unless the map data is being updated as such changes are occurring. To further complicate matters, it can be prohibitively difficult to rely on municipal planning information to accurately update the map data. The municipal planning information may, itself, be inaccurate regarding precise changes that are being made, date when the change will occur, etc. Moreover, there is no common standard in which the daunting number of municipalities use to record, manage, share, etc. such planning information. Therefore, any such effort to gather map data by way of municipality planning information may be prohibitively inaccurate, varied, and logistically complex.

Therefore, a common approach to updating map data has been to send a data gathering vehicle along a route that is desired to be updated. The goal behind such an approach is for the data gathering vehicle to obtain as much map data as possible so that there is no need to send another vehicle to gather data along that particular route, unless there is a likelihood that a change has occurred along the particular route. For example, under this approach, it may be considered wasteful to send a data gathering vehicle to gather a particular type of map data, and to also send another data gathering vehicle to gather a different type of map data. In addition, even though there may be benefits to having a small amount of redundancy in the data gathering routes, such redundancy lowers the perceived efficiency of the data gather process under this approach.

Due to the vast amount of map data to be updated, efficiency is a critical aspect for a map data updating process. For example, the previously discussed strategy of sending data gathering vehicles on predetermined routes is a very expensive process. Such a process involves at least one person, but often two people per vehicle. These people will need to be paid for at least the duration of the data gathering mission. When measuring this expense against the vast number of road segments throughout the world, it is easy to see that even a small amount of inefficiency can dramatically increase the cost of updating the map data.

Therefore, the common approach has been to gather as much data as possible during each mission for the data gathering vehicle. In addition, due to the importance of the integrity of the map data, a high level of precision for the location of the data gathering vehicle is desirable. For example, a larger variance in the determined position may introduce difficulties in properly utilizing the data gathered by the data gathering vehicle, may introduce errors into the data gathered by the data gathering vehicle, and/or the like. In order to achieve this goal, data gathering vehicles require a vastly large, heavy, expensive, and highly power consuming set of equipment.

It can be seen, in FIGS. 3A and 3B, that equipment cluster 302 comprises GPS antenna 309, light detection and ranging (LIDAR) sensor 311, camera cluster 308, mast 307, sensor socket panel 306, base 304, mast stabilizer 313, mast stabilizer actuator 314, cable deflector 312, and mounts 303A-D. It can be seen that camera cluster comprises cameras 310A-D.

It is likely desirable for GPS antenna 309 to be a specialized GPS antenna so that the equipment can receive stronger GPS signals. In this manner, the location of the data gathering vehicle can be determined with a greater level of precision. It is likely desirable to include camera cluster 308 to provide images that can be later analyzed for navigational features, presented to users, and/or the like. It is likely desirable to include LIDAR sensor 311 to provide enhanced depth information, because LIDAR likely provides better depth sensing than that available by mere photography. In order to avoid damage to GPS antenna 309 and LIDAR sensor 311, it may be desirable to include cable deflector 312, which, in the circumstance of a collision with a low-hanging cable, guides the cable over the top of GPA antenna 309, LIDAR sensor 311, and/or the like. In order to avoid having other vehicles obstruct LIDAR sensor 311 and camera cluster 308, it is likely desirable to mount LIDAR sensor 311 and camera cluster 308 on mast 307. In addition, mast 307 may be utilized to store wires that extend from GPS antenna 309, LIDAR sensor 311, and camera cluster 308. Furthermore, in order to avoid undesirable sensor movement during data gathering, it is likely desirable to include mast stabilizer 313 to dampen the effect of acceleration and deceleration on mast 307. Furthermore, mast stabilizer 313 may be adjustable. For example, mast stabilizer actuator 314 may actuate mast stabilizer 313 to adjust the angle of mast 307. In this manner, mast stabilizer actuator 314 may cause raising and lowering of mast 307 by way of actuating mast stabilizer 313. In addition, it is likely desirable to include sensor socket panel 306 to allow for quick connection and disconnection of sensor wires.

FIGS. 3A and 3B illustrate a portion of equipment utilized for gathering map data using vehicle 301. Even though the examples of FIGS. 3A and 3B merely illustrate equipment cluster 302 in relation to vehicle 301, it should be understood that much more equipment is often utilized in a data gathering mission. For example, a computer may be required to drive the equipment of equipment cluster 302, to receive data from equipment cluster 302, to process data received from equipment cluster 302, to store data received from cluster 302, and/or the like. For example, the vast amount of data obtained during a data gathering mission necessitates a large amount of computer writable data storage for storing the obtained data. In addition, the computer is often controlled by a human operator. For safety purposes, it may be desirable to avoid having the driver operate the computer (thus having two people aboard the data gathering vehicle may be desirable, as previously discussed). This operator typically needs an elaborate interface to manage the computer. For example, there may be a touch display connected to the computer that allows the operator to manage the data gathering process. In this manner, the operator can manage the data gathering process in real-time, and can avoid the inefficiency of proceeding with a data gathering mission when the data gathering system has unknowingly become compromised. Thus, the interface to the computer may allow the operator to monitor for problems, to correct problems, to pause the data gathering mission to avoid proceeding when data cannot be properly gathered, etc. FIG. 3C illustrates a data gather vehicle being driven by driver 321. In the example of FIG. 3C, operator 322 can manage the data gather by way of the interface of touchscreen 323. Even though the example of FIG. 3C illustrates touchscreen 323 being affixed to the dashboard of the vehicle, the touchscreen does not necessarily need to be affixed to the vehicle. For example, the touchscreen may be removable, may be held by the operator, etc.

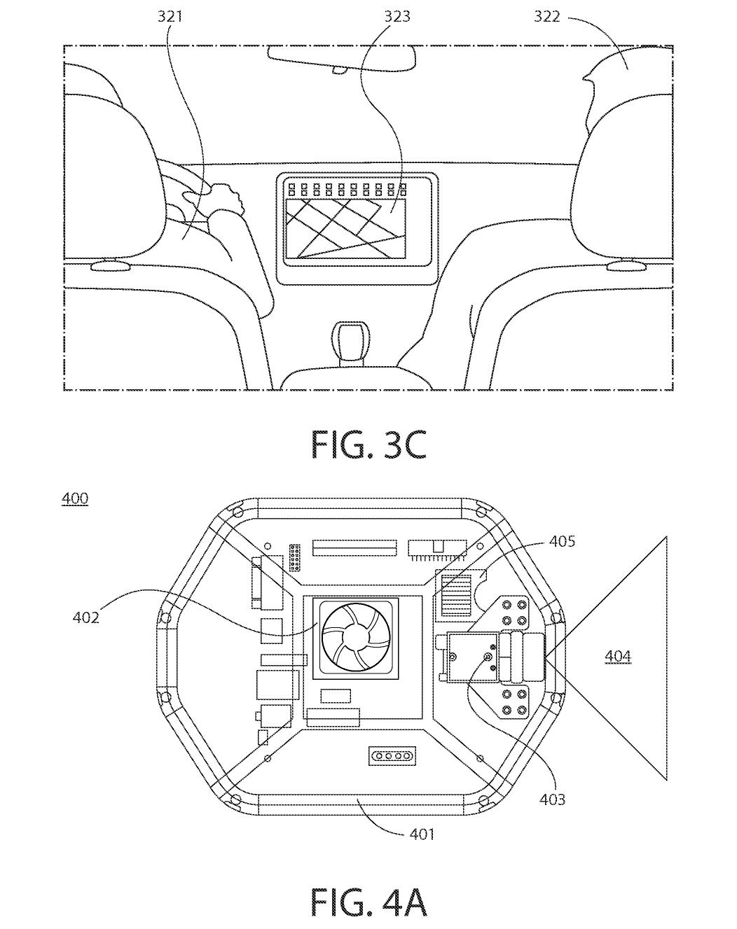

FIGS. 4A-4B are diagrams illustrating a host vehicle sensor apparatus according to at least one example embodiment. The example of FIGS. 4A-4B are merely examples and do not necessarily limit the scope of the claims. For example, configuration of the host vehicle sensor apparatus may vary, devices comprised by the host vehicle sensor apparatus may vary, position of devices comprised by the host vehicle sensor apparatus may vary, and/or the like.

Even though the data obtained by way of specialized data gathering vehicles may be highly desirable, it can be seen that this strategy for data gathering is highly expensive, often requires specialized vehicles, etc. For example, for each data gathering vehicle, there must be two employees or contractors, a vastly expensive set of equipment, and the vehicle itself. The vehicle must be deployed on a continuous basis and navigated in a highly planned manner that optimizes the route of the data gathering vehicle. In large areas, especially large areas that are undergoing vast changes, it would be highly desirable, if not necessary, to operate several vehicles concurrently. Furthermore, there would need to be a centralized data processing center that would compile the gathered data, process the gathered data, and update the map data repository, such as the computer described regarding FIG. 3. Therefore, it may be highly desirable to develop an alternative data gathering strategy that is much less expensive.

One such unique strategy is to utilize vehicles that are already driving extensively throughout a region, such as shipment vehicles, delivery vehicles, municipal vehicles, and/or the like as host vehicles for sensors. In this manner, a host vehicle sensor apparatus may be used on the host vehicle to gather data. Thus, the expense of having employees driving and maintaining separate vehicles for the sole purpose of data gathering can be eliminated. However, in eliminating the presence of the data gathering employees, there will likely be no people present in the host vehicle who are trained to operate any specialized data gathering equipment. Therefore, under such a data gathering strategy, it may be desirable to greatly reduce or even eliminate the interface involved with operating the host vehicle sensor apparatus in comparison to the interface of the data gathering vehicle. Furthermore, there is much greater availability of host vehicles than data gathering vehicles. Therefore, it may be desirable to reduce the cost of the host vehicle sensor apparatus to allow for mass distribution of the host vehicle sensor apparatus into a large number of host vehicles. In addition, since each host vehicle will be operated for purposes that are independent of data gathering, it may be desirable for the host vehicle sensor apparatus to be sized small enough to be unobtrusive to the host vehicle operator. In this manner, redundancy of data gathering will be based on frequency of use, rather than forcibly applied to a predetermined data gathering route.

Such a drastically different data gathering strategy necessitates a dramatic difference between the host vehicle sensor apparatus and the data gathering vehicle equipment cluster. For example, it may be desirable to limit one or more physical characteristics of the host vehicle sensor apparatus. In another example, it may be desirable to limit the functional capabilities of the host vehicle sensor apparatus. In even another example, it may be desirable to limit user input capabilities of the host vehicle sensor apparatus. In yet another example, it may be desirable to limit output capabilities of the host vehicle sensor apparatus. In still another example, it may be desirable to limit power requirements of the host vehicle sensor apparatus. Furthermore, in view of these desirable limitations, it may be desirable to limit the amount of data and/or the type of data that the host vehicle sensor apparatus obtains, stores, transmits, and/or the like.

As previously discussed, it may be desirable to limit one or more physical characteristics of the host vehicle sensor apparatus. As previously described, it may be desirable for the driver of the host vehicle to be able to utilize the host vehicle with minimal intrusion by the host vehicle sensor apparatus. In this manner, it may be desirable for the host vehicle sensor apparatus to be simple to install by one person, simple to remove by one person, easy for one person to move the host vehicle sensor apparatus from one host vehicle to another host vehicle, etc. In this manner, it is desirable to limit size and weight of the host vehicle sensor apparatus to a size and weight that enables such desirable utilization scenarios. For example, it is desirable for the host vehicle sensor apparatus to be light and compact. In this manner, the physical characteristics may not be a merely coincidental aspect of the host vehicle sensor apparatus, but may be pertinent to the manner in which the host vehicle sensor apparatus fulfils its purpose. In at least one example embodiment, the host vehicle sensor apparatus weighs less than 10 pounds. For example, the host vehicle sensor apparatus may weigh 8 pounds, 6 pounds, 4 pounds, or even less.

In at least one example embodiment, the host vehicle sensor apparatus comprises a housing that encloses various elements of the host vehicle sensor apparatus. In at least one example embodiment, the host vehicle sensor apparatus comprises a single housing. Without necessarily limiting the claims in any way, at least one technical advantage associated with having a single housing is to allow for easier transportation of the host vehicle sensor apparatus, less interference of the host vehicle sensor apparatus with the intended function of the host vehicle, and/or the like. As previously described, it may be desirable for the host vehicle sensor apparatus to be compact. In at least one example embodiment, the housing has a volume that is less than or substantially equal to 1.125 cubic feet. For example, the housing may be 18 inches wide, 18 inches deep, and 6 inches tall. In at least one example embodiment, the housing has a volume that is less than or substantially equal to 0.5 cubic feet. For example, the housing may be 12 inches wide, 12 inches deep, and 6 inches tall. In at least one example embodiment, the housing has a volume that is less than or substantially equal to 0.23 cubic feet. For example, the housing may be 8 inches wide, 8 inches deep, and 6 inches tall. In at least one example embodiment, substantially equal refers to being equal within a threshold manufacturing tolerance. Such a small volume may allow the host vehicle sensor apparatus to be mounted in a host vehicle very easily. For example, the host vehicle sensor apparatus may be mounted easily within the vehicle, such as on a dashboard, a visor, a windshield, and/or the like. Similarly, the host vehicle sensor apparatus may be mounted easily outside of the vehicle, such as on the roof, the hood, and/or the like.

However, in addition to the limitation of physical characteristics, it may be desirable to provide additional physical characteristics for the host vehicle sensor apparatus due to the particular data gathering strategy that it is designed to facilitate. In this manner, the physical characteristics may not be a merely coincidental aspect of the host vehicle sensor apparatus, but may be pertinent to the manner in which the host vehicle sensor apparatus fulfils its purpose. For example, it may be desirable to avoid requiring any particular mount to be affixed to the host vehicle for attaching the host vehicle sensor apparatus to the host vehicle. For example, it may be desirable to avoid a need for a specific gutter mount, cargo rail, etc. In this manner, it may be desirable for the host vehicle sensor apparatus to be attachable to a generally smooth surface of the host vehicle. In at least one example embodiment, the housing is magnetically mountable to the host vehicle. In at least one example embodiment, the housing is mountable to the host vehicle by way of suction, such as one or more suction cups. In some circumstances, such suction cups may be controllable by various mechanical supplements, such as a lever, an adjustment screw, and/or the like. Thus, the host vehicle sensor apparatus may be configured to attach to a wide variety of host vehicles. In at least one example embodiment, the housing of the host vehicle sensor apparatus comprises at least one magnet that is configured to affix the housing to an automobile. In at least one example embodiment, the force of the one or more magnets is greater than the weight of the housing. For example, the host vehicle sensor apparatus may weigh 10 pounds and the magnets may have a force of 12-24 pounds. In such an example, the housing may comprise 4 magnets, where each magnet has a force of 3-6 pounds.

Furthermore, in order to be mountable on the exterior of the host vehicle, it may be desirable for the host vehicle sensor apparatus to have a housing that protects components from an outdoor environment. In at least one example embodiment, the housing is water resistant. For example, the housing may have an outer surface that is water resistant. In such an example, seams and/or ports on the housing may have gaskets that resist water infiltration.

As previously discussed, it may be desirable to limit user input capabilities of the host vehicle sensor apparatus. For example, as previously discussed, it is desirable to allow the host vehicle sensor apparatus to operate without assistance of an operator. Therefore, the driver of the host vehicle can avoid the need to manage the operation of the host vehicle sensor apparatus, and be free to perform his normal duties. In this manner, the user input limitations may not be a merely coincidental aspect of the host vehicle sensor apparatus, but may be pertinent to the manner in which the host vehicle sensor apparatus fulfils its purpose. In at least one example embodiment, the host vehicle sensor apparatus fails to comprise any user input device. In this manner, the driver of the host vehicle can avoid managing the host vehicle sensor apparatus. In at least one example embodiment, a user input device refers to an input device that is configured to receive an input from the user that allows the user to influence the manner in which the host vehicle sensor apparatus operates.

Consequently, such a lack of a user input device facilitates the limitation of memory of the host vehicle sensor apparatus. For example, the memory will fail to comprise particular computer program code for the user input. In at least one example embodiment, the computer program code fails to comprise instructions that require a user input. For example, the computer program code may fail to include any instruction for operating a user input device, for interpreting information received from a user input device, and/or the like. In at least one example embodiment, the computer program code fails to comprise any instructions that predicate any action upon any user input. For example, the computer program code may be absent any instructions that are conditioned upon any user input, such as a branch based on a user input, a case statement that switches on a user input, an if statement that evaluates a user input, and/or the like. Consequently, absent such elements, the computer program code will allow for autonomous operation of the host vehicle sensor apparatus. In at least one example embodiment, the computer program code comprises instructions that cause the apparatus to operate absent any user input.

In some circumstances, it may be desirable for the driver to have a small amount of control of the host vehicle sensor apparatus. For example, it may be desirable to allow the driver to turn the host vehicle sensor apparatus on, to turn the host vehicle sensor apparatus off, to reset the host vehicle sensor apparatus, and/or the like. In at least one example embodiment, the host vehicle sensor apparatus comprises a user input device that selectively initiates or terminates operation of the host vehicle sensor apparatus. In at least one example embodiment, a user input device that selectively initiates or terminates operation refers to a power switch, a power button, a reset button, and/or the like. However, in such circumstances, it may be desirable to limit the availability of input to the user input device that selectively initiates or terminates operation. In at least one example embodiment, the host vehicle sensor apparatus comprises a single user input device that selectively initiates or terminates operation of the host vehicle sensor apparatus. For example, the host vehicle sensor apparatus may fail to comprise any input device other than the single input device that selectively initiates or terminates operation of the host vehicle sensor apparatus.

As previously discussed, it may be desirable to limit output capabilities of the host vehicle sensor apparatus. For example, as previously discussed, it is desirable to allow the host vehicle sensor apparatus to operate without distracting a driver of the host vehicle. Therefore, the driver of the host vehicle can allow the host vehicle sensor apparatus to operate, while being able to perform his normal duties without distraction from the host vehicle sensor apparatus. In this manner, the output limitations may not be a merely coincidental aspect of the host vehicle sensor apparatus, but may be pertinent to the manner in which the host vehicle sensor apparatus fulfils its purpose. In at least one example embodiment, the host vehicle sensor apparatus fails to comprise any output device. For example, the host vehicle sensor apparatus may fail to comprise a display, a light, a tactile output device, and/or the like. However, in some circumstances, it may be desirable for the driver of the host vehicle to be able to observe whether or not the host vehicle sensor apparatus is operating. For example, the driver may have been instructed to continuously use that host vehicle sensor apparatus when driving the vehicle, to avoid using the host vehicle sensor apparatus in particular circumstances, and/or the like. In order to allow the driver to correctly ascertain whether or not the host vehicle sensor apparatus is operating, it may be desirable to provide an output device that indicates an operational status of the apparatus. In at least one example embodiment, an output device that indicates operational status may be a light, a periodic audio signal, and/or the like. In at least one example embodiment, the host vehicle sensor apparatus comprises an output device that indicates the operational status of the host vehicle sensor apparatus. In this manner, the driver may ascertain whether or not the host vehicle sensor apparatus is operating. In some circumstances, it may be desirable to limit the host vehicle sensor apparatus to only include an output device that indicates operational status of the host vehicle sensor apparatus. In at least one example embodiment, the host vehicle sensor apparatus comprises a single output device that indicates operational status of the apparatus. For example, the host vehicle sensor apparatus may fail to comprise any output device other than the single output device.

As previously discussed, it may be desirable to limit power requirements of the host vehicle sensor apparatus. For example, it may be desirable to allow the connecting of the host vehicle sensor apparatus to power from the host vehicle to be simple and unobtrusive. For example it may be desirable to avoid forcing the driver to be burdened with an elaborate connection process when the driver is readying the host vehicle sensor apparatus to be used in conjunction with a host vehicle. In this manner, it may be desirable for the host vehicle sensor apparatus to be powered by way of a power outlet that is readily available on a variety of host vehicles. In this manner, even a driver with limited mechanical skill will be capable of preparing the host vehicle sensor apparatus for operation at host vehicle. In at least one example embodiment, the host vehicle sensor apparatus comprises a power cable that is configured to connect to an electrical outlet of the host vehicle. In at least one example embodiment, the electrical outlet is an automobile cigarette lighter electrical outlet, a 12V auxiliary power outlet, and/or the like. In at least one example embodiment, the host vehicle sensor apparatus comprises a power cable that extends outward from the housing and is configured to connect to an electrical outlet of a vehicle. In at least one example embodiment, the power cable is the only electrical connection that the host vehicle sensor apparatus has with the host vehicle. For example, the host vehicle sensor apparatus may fail to comprise any cable that extends outwardly from the housing other than the power cable.

As previously discussed, it may be desirable to limit the functional capabilities of the host vehicle sensor apparatus. For example, it may be desirable to limit expense of producing the host vehicle sensor apparatus by limiting the functional capabilities of the host vehicle sensor apparatus. Furthermore, limiting the functional capabilities of the host vehicle sensor apparatus also facilitates the previously described limiting of the physical characteristics of the host vehicle sensor apparatus. In at least one example embodiment, the host vehicle sensor apparatus comprises at least one processor, such as processor 11 of FIG. 1, and at least one memory, such as memory 12 of FIG. 1. However, it may be desirable to limit the capabilities of the processor and/or the memory. For example, it may be desirable to limit the amount of volatile memory, to limit the amount of nonvolatile memory, and/or the like. For example, it may be desirable to reduce or eliminate storage of captured data (such as sensor data, data derived from sensor data, etc.) in nonvolatile memory. For example, even though the equipment of the example of FIGS. 3A-3C require a large amount of nonvolatile memory for storing the vast amounts of data that the equipment captures, the amount of nonvolatile memory for the host vehicle sensor apparatus may be greatly reduced by avoiding storage of captured data on the host vehicle sensor apparatus. Furthermore, it may be desirable to reduce the amount of volatile memory of the host vehicle sensor apparatus by reducing the amount of data that the host vehicle sensor apparatus captures, limiting the type of data that the host vehicle sensor apparatus captures, limiting the amount of data that the host vehicle sensor apparatus processes at a given time, and/or the like. In this manner, the functional capabilities may not be a merely coincidental aspect of the host vehicle sensor apparatus, but may be pertinent to the manner in which the host vehicle sensor apparatus fulfils its purpose.

However, in addition to the limitation of functional capabilities, it may be desirable to provide particular functional capabilities for the host vehicle sensor apparatus due to the particular data gathering strategy that it is designed to facilitate. Furthermore, by strategically defining the functionality of the host vehicle sensor apparatus, the functionality itself may facilitate the limitation of the physical characteristics of the host vehicle sensor apparatus, the functional capabilities of the host vehicle sensor apparatus, user input capabilities of the host vehicle sensor apparatus, output capabilities of the host vehicle sensor apparatus, power requirements of the host vehicle sensor apparatus, amount of data and/or the type of data that the host vehicle sensor apparatus obtains, and/or the like.

It may be desirable for the host vehicle sensor apparatus to avoid retaining data that has been gathered. For example, it may be desirable to limit the host vehicle sensor apparatus to merely have transient storage of the data that is gathered. In this manner, the host vehicle sensor apparatus may relegate storage of gathered data to volatile memory. However, in order to facilitate the use of the gathered data, the host vehicle sensor apparatus may send the gathered data, data derived from the gathered data, and/or the like to a separate apparatus. For example, the host vehicle sensor apparatus may send data to a map data repository. In this manner, it may be desirable for the host vehicle sensor apparatus to comprise a wireless communication device that is configured to transmit data to the map data repository. Such a wireless communication device would, therefore, enable the host vehicle sensor apparatus to avoid storage of gathered data in nonvolatile memory.

However, it may be further desirable to avoid sending the entirety of the gathered data to a map data repository. For example, it may be desirable to avoid the expense of wirelessly transmitting all of the data that is gathered by the host vehicle sensor apparatus, reduce an amount of time consumed by the transmission of the data, and/or the like. Therefore, it may be desirable for the host vehicle sensor apparatus to selectively identify data that is worthwhile to send to the map data repository. However, such identification of gathered data can be a very complex and expensive task to perform, in many circumstances. Therefore, determining which data to capture, which evaluations of the data to perform, and which data warrants sending to the map data repository, etc. is a very complex determination.

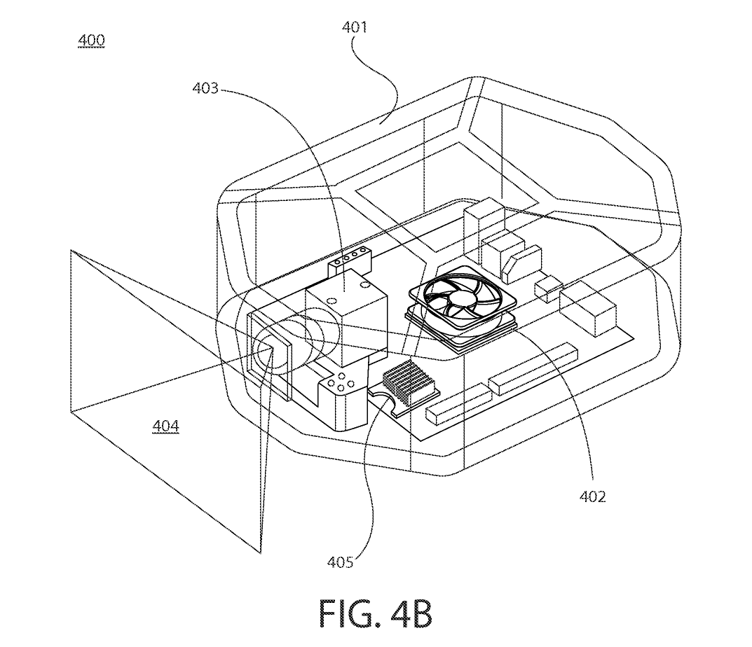

In evaluating the vast changes that many maps undergo, studies have shown that a large percentage of such changes involve navigational features, such as speed limits, lane count, lane arrangement, road-signs, information conveyed by road-signs, etc., similar as described regarding FIG. 5. However, it can be a very serious problem for such navigational features to become outdated in the geographical database. For example, miscommunication of speed limit information may cause inaccurate route calculations, inaccurate arrival time calculations, or even unsafe driving behavior in reliance on the outdated navigational feature data. Furthermore, navigational feature data is a concise data element that may be communicated without transmitting a large amount of other data to the map data repository (such as visual information, LIDAR data, etc.).

Therefore, it may be desirable for the host vehicle sensor apparatus to be a navigational feature identification apparatus. In this manner, the host vehicle sensor apparatus may be an apparatus that specializes in gathering data, identifying navigational features that are indicated by the gathered data, and sending appropriate navigational feature data to the map data repository. In this manner, the host vehicle sensor apparatus may serve to continuously update the navigational feature data of the map data repository by way of identifying navigational features along the route of the host vehicle and sending navigational feature data to the map data repository based, at least in part, on the identified navigational features.

In this manner, it may be desirable to limit the functional characteristics of the host vehicle sensor apparatus to functionality that furthers the gathering of data that allows for identification of navigational features, performing identification of navigational features, and sending navigational feature data to the map data repository. Therefore, it may be desirable for the host vehicle sensor apparatus to comprise at least one camera module. In this manner, the host vehicle sensor apparatus may utilize the camera module to capture visual information, and analyze the visual information to identify navigational features that are represented by the visual information. In at least one example embodiment, the host vehicle sensor apparatus comprises at least one camera module. As previously described, it may be desirable for the housing to protect the components of the host vehicle sensor apparatus. Therefore, in at least one example embodiment, the housing is configured to enclose the camera module. In such an embodiment, the housing comprises at least one aperture through which the camera module is configured to capture visual information. The aperture may be any opening that allows light to reach the camera module. The aperture may be sealed by a lens that protects the camera module while allowing light outside of the housing to reach the camera module. In at least one example embodiment, the camera module is configured to interact with the processor. For example, there may be at least one electrical path, at least indirectly, between the camera module and the processor that allows for control signals and/or data signals to be sent and/or received between the processor and the camera module.

The visual information captured by the camera module may be single image information, video information, and/or the like. However, it should be understood that video information may be utilized to derive an image. In this manner, regardless of the type of visual information received from the camera module, the host vehicle sensor apparatus may, nonetheless, receive an image from the camera module.

In many circumstances, the host vehicle sensor apparatus may be able to adequately identify navigational features by way of images captured by the camera module. For example, the host vehicle sensor apparatus may avoid utilization of other sensor information, such as LIDAR sensor information, infra-red sensor information, and/or the like. In at least one example embodiment, the host vehicle sensor apparatus fails to comprise any LIDAR sensor. In at least one embodiment, the host vehicle sensor apparatus fails to comprise any infra-red sensor. In this manner, the cost of the host vehicle sensor apparatus may be reduced, in comparison with the equipment of the example of FIGS. 3A-3C.

However, in some circumstances, it may be beneficial for the host vehicle sensor apparatus to comprise additional sensors, such as a LIDAR sensor, an infra-red sensor, and/or the like. For example, it may be desirable for the host vehicle sensor apparatus to be able to receive detailed depth information, heat information, and/or the like. In at least one example embodiment, the host vehicle sensor apparatus comprises at least one LIDAR sensor. In at least one example embodiment, the host vehicle sensor apparatus comprises at least one infra-red sensor.

In the example of FIGS. 4A-4B host vehicle sensor apparatus 400 comprises housing 401, processor 402, camera module 403, and memory 405. It can be seen that housing 401 is configured to enclose processor 402, camera module 403, and memory 405. It can be seen that housing 401 comprises an aperture though which camera module 403 may capture visual information. For example, it can be seen that the aperture allows camera module to receive light according to field of view 404 by way of the aperture. Even though not shown, housing 401 may comprise a lens within the aperture of housing 401.

FIG. 5 is a diagram illustrating representations of navigational features according to at least one example embodiment. The example of FIG. 5 is merely an example and does not necessarily limit the scope of the claims. For example, number of representations may vary, navigational features may vary, information conveyed by the navigational features may vary, and/or the like. It should be understood that there are many manners in which navigational features may be identified, and that there may be many manners for identifying navigational features in the future. Therefore, the manner in which navigational features are identified does not necessarily limit the claims in any way.

In at least one example embodiment, an apparatus identifies one or more navigational features by way of analyzing one or more images. For example, the apparatus may capture an image by way of a camera module, such as camera module 403 of FIGS. 4A-4B. In at least one example embodiment, the apparatus identifies at least one navigational feature that is represented in the image. For example, the image may comprise visual information that is consistent with a navigational feature. In this manner, the apparatus may identify such visual information as a navigational feature.

The example of FIG. 5 illustrates various navigational features that that an apparatus has identified in image 500. It can be seen that the apparatus has identified lane striping 501, 502, 503, and 504. It can also be seen that the apparatus has identified traffic signals 505, 506, 507, and 508.

In at least one example embodiment, the apparatus evaluates one or more images against information that is used to identify one or more predetermined types of navigational demarcations. In at least one example embodiment, a navigational demarcation signifies a physical element that serves as a communication of a particular aspect of navigation to a driver. For example, the navigation demarcation may be a road sign, a curb, a lane marker, a traffic signal, and/or the like. In such an example, a road sign may be a speed limit sign, an exit notification sign, a road segment designation sign (such as a mile marker), a detour sign, a traffic control sign, and/or the like. In this manner, the apparatus may identify a portion of the image to be a representation of a predetermined type of navigational demarcation. For example, the apparatus may determine that a particular portion of the image is a representation of a speed limit sign. It can be seen in the example of FIG. 5 that the apparatus has identified portions of image 500 to comprise representations of traffic signals, namely, the portions of image 500 that include the highlighted representations of traffic signals 505, 506, 507, and 508. In such an example, the apparatus may identify these representations as being representations of the predetermined type of navigational demarcation that is a traffic signal. In at least one example embodiment, the navigational feature comprises information indicative of the predetermined type of navigational demarcation. For example, the navigational feature determined for lane striping 502 may comprise information indicative of the navigational feature being lane striping. In this manner, later evaluation of the navigational feature data may allow another apparatus to treat the navigational feature as lane striping.

In some circumstances, there may be supplemental information associated with a particular navigational demarcation. For example a road sign may have printed information, a traffic signal may have particular characteristics (for example one or more turn signals), lane striping may signify particular limitations (for example, whether or not a lane change is allowed, direction of traffic flow in an adjacent lane, etc.), and/or the like. In at least one example embodiment, after the apparatus identifies a portion of the image to be a representation of a predetermined type of navigational demarcation, the apparatus recognizes a subportion of the portion of the image to be a representation of supplemental information associated with the navigational feature. For example, the apparatus may identify a portion of a representation of lane striping to signify supplemental information of a no-passing designation. In another example, the apparatus may identify a portion of a representation of a traffic signal to signify supplemental information of a turn signal.

In at least one example embodiment, the apparatus identifies a portion of the image to be a representation of a road sign. In such an example, the apparatus may recognize a subportion of the portion of the image to be a representation of road sign information, such as textual information, graphical information, and/or the like that is conveyed by the sign. In such an example, the apparatus may perform pattern recognition on the subportion to determine road sign conveyance data. Road sign conveyance data may refer to information that the road sign conveys, such as a speed limit, an exit identification, a mile marker, etc. For example, the apparatus may preform image recognition to identify graphical information, may perform character recognition to identify textual information, and/or the like. In this manner, the apparatus may identify a road sign as a speed limit sign, may identify a speed limit conveyed by a speed limit sign, and/or the like. In such an example, the navigational feature data for the road sign may comprise information that signifies that the navigational feature signified by the navigational feature data is a road sign, as opposed to a different type of navigational demarcation. In at least one example embodiment, the navigational feature data comprises information indicative of road sign conveyance data. For example the navigational feature data may comprise information indicative of a speed limit conveyed by a speed limit sign.

As previously described, it may be desirable for the apparatus to comprise a communication device to send navigational feature data to the map data repository. It should be understood that navigational feature data may be any information that represents the navigational feature in a manner that enables another apparatus to determine at least one aspect of the navigational feature. In this manner, the navigational feature data may be any information that is indicative of the navigational feature.

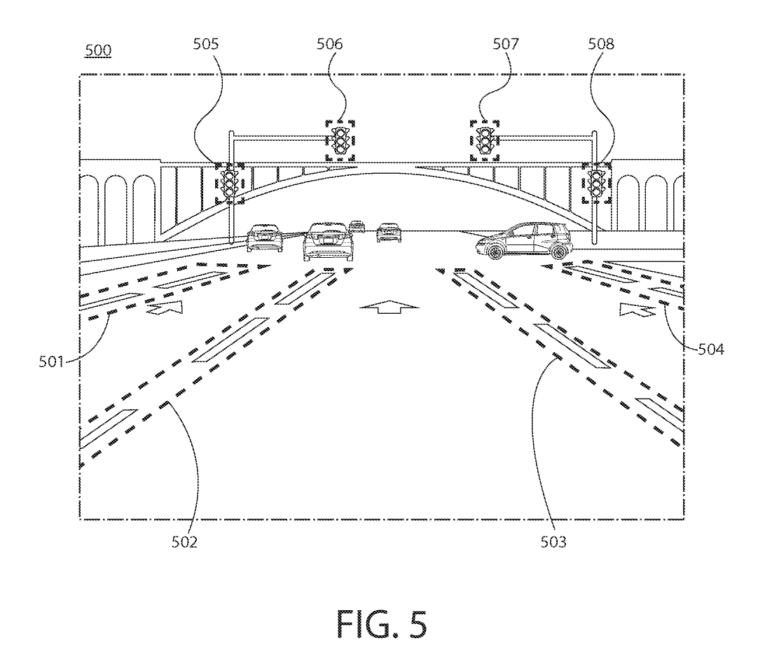

FIG. 6 is a flow diagram illustrating activities 600 associated with identification of a navigational feature according to at least one example embodiment. In at least one example embodiment, there is a set of operations that corresponds with the activities of FIG. 6. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform the set of operations of FIG. 6.

As previously described, focusing the functional capabilities of the apparatus towards particular map data gathering helps to achieve the apparatus description of FIGS. 4A-4B. For example, gathering data, identifying navigational features in the data, and sending navigational feature data to a map data repository may serve to reduce memory of the apparatus. In addition, this manner of real time evaluation of data allows the apparatus to reduce the amount of memory associated with storing data that is pending analysis.

At block 602, the apparatus, captures at least one image. The capture and the image may be similar as described regarding FIGS. 4A-4B, FIG. 5, and/or the like. The image may be captured by way of a camera module.

At block 604, the apparatus identifies at least one navigational feature that is represented in the image. The identification, and the navigational feature may be similar as described regarding FIG. 5.

At block 606, the apparatus sends information indicative of the navigational feature to a map data repository. The sending, the information indicative of the navigational feature, and the map data repository may be similar as described regarding FIG. 2, FIGS. 4A-4B, FIG. 5, and/or the like. The apparatus may send the information indicative of the navigational feature by way of a communication device.

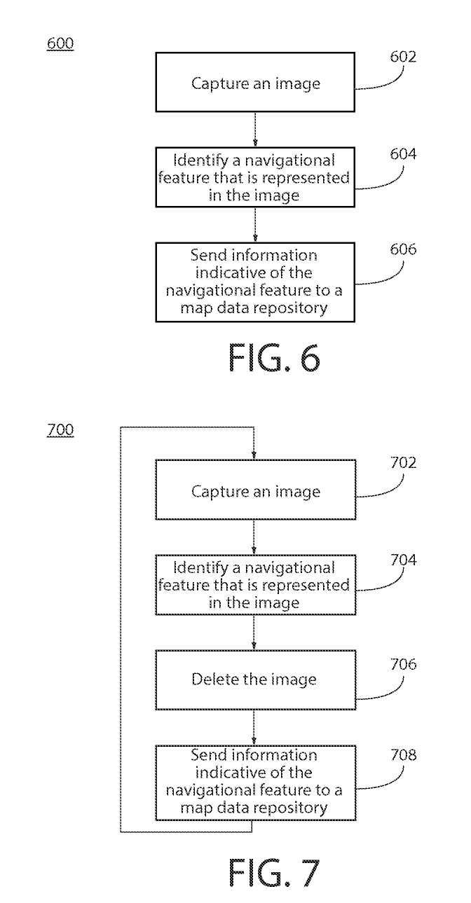

FIG. 7 is a flow diagram illustrating activities 700 associated with identification of a navigational feature according to at least one example embodiment. In at least one example embodiment, there is a set of operations that corresponds with the activities of FIG. 7. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform the set of operations of FIG. 7.

As previously discussed, it may be highly desirable to limit the amount of memory that the apparatus utilizes for processing data. Therefore, it may be desirable to delete an image after the image has been analyzed. In this manner, the apparatus may delete the image after the apparatus identifies navigational features, after the apparatus sends information of the navigational features, and/or the like. In at least one example embodiment, the apparatus deletes the image before the apparatus captures another image. In this manner, the apparatus may reduce the amount of memory associated with storing multiple images. In this manner, the apparatus may relegate image storage to volatile memory. However, in circumstances where it may be desirable to perform navigational feature identification by way of more than one image, the apparatus may retain a fixed number of images and delete older images as new images are captured so that the apparatus may avoid exceeding storage of images beyond a threshold number of images. In at least one example embodiment, the apparatus avoids storage of the image in nonvolatile memory. In at least one example embodiment, the apparatus sends, at least part of, the image to the map data repository. In such an example, the apparatus may delete the image subsequent to such sending operation. Conversely, it may be desirable to further limit the amount of data sent by the apparatus. In at least one example embodiment, the apparatus precludes sending of any part of the image to the map data repository. In such an example, the apparatus may delete the image without sending any portion of the image to the map data repository.

At block 702, the apparatus captures at least one image, similarly as described regarding block 602 of FIG. 6. At block 704, the apparatus identifies at least one navigational feature that is represented in the image, similarly as described regarding block 604 of FIG. 6.

At block 706, the apparatus deletes the image.

At block 708, the apparatus sends information indicative of the navigational feature to a map data repository, similarly as described regarding block 606 of FIG. 6.

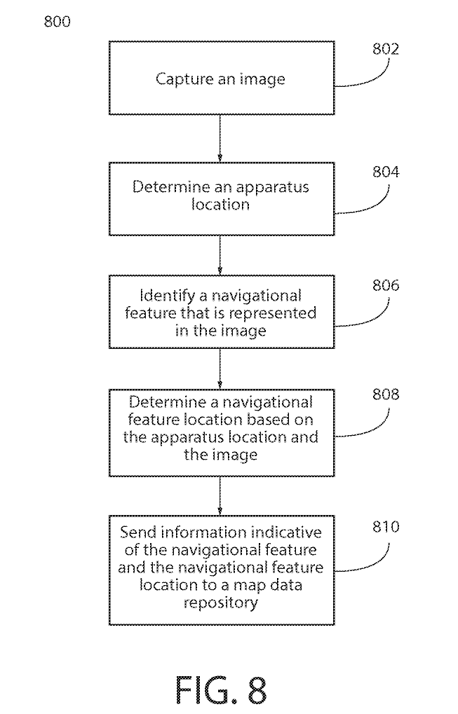

FIG. 8 is a flow diagram illustrating activities 800 associated with identification of a navigational feature according to at least one example embodiment. In at least one example embodiment, there is a set of operations that corresponds with the activities of FIG. 8. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform the set of operations of FIG. 8.

In some circumstances, it is important for the navigational feature data to be correlated with a location. In this manner, the geographic database may comprise a data association between the navigational feature and a particular geographic location of the navigational feature. In at least one example embodiment, the apparatus determines its position. For example the apparatus may determine an apparatus location that signifies the location of the apparatus. In at least one example embodiment, the apparatus determines a navigational feature location that signifies the location of the navigational feature. In at least one example embodiment, the apparatus determines the navigational feature location based, at least in part, on the apparatus location. For example, the apparatus may determine that the navigational feature location is an offset from the apparatus location. In at least one example embodiment, the apparatus determines the navigational feature location based, at least in part, on the apparatus location and the image. For example the apparatus may determine an offset from the apparatus location based, at least in part, on the image. The apparatus may apply the offset to the apparatus location to determine the navigational feature location. Such a determination may be further based on a determined orientation of the apparatus. In such an example, the apparatus may apply the offset to the apparatus location in a direction that corresponds with an orientation of the camera module. In at least one example embodiment, the apparatus sends information indicative of the navigational feature location to the map data repository. In this manner, the map data repository may retain a data association between the navigational feature location and the navigational feature.

At block 802, the apparatus captures at least one image, similarly as described regarding block 602 of FIG. 6.

At block 804, the apparatus determines an apparatus location. At block 806, the apparatus identifies at least one navigational feature that is represented in the image, similarly as described regarding block 604 of FIG. 6.

At block 808, the apparatus determines a navigational feature location based, at least in part, on the apparatus location and the image.

At block 810, the apparatus sends information indicative of the navigational feature and information indicative of the navigational feature location to a map data repository. The sending, the information indicative of the navigational feature, and the map data repository may be similar as described regarding FIG. 2, FIGS. 4A-4B, FIG. 5, and/or the like. The apparatus may send the information indicative of the navigational feature by way of a communication device.

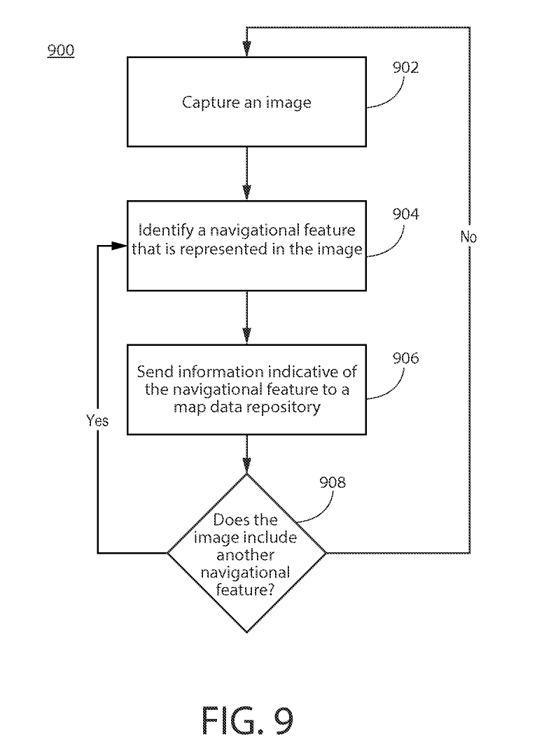

FIG. 9 is a flow diagram illustrating activities 900 associated with identification of a navigational feature according to at least one example embodiment. In at least one example embodiment, there is a set of operations that corresponds with the activities of FIG. 9. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform the set of operations of FIG. 9.

As previously discussed, the apparatus may identify more than one navigational feature in an image. In this manner, the apparatus may perform multiple navigational feature identifications on the image.

At block 902, the apparatus captures at least one image, similarly as described regarding block 602 of FIG. 6. At block 904, the apparatus identifies at least one navigational feature that is represented in the image, similarly as described regarding block 604 of FIG. 6. At block 906, the apparatus sends information indicative of the navigational feature to a map data repository, similarly as described regarding block 606 of FIG. 6.

At block 908, the apparatus determines whether the image includes another navigational feature. If the apparatus determines that the image includes another navigational feature, flow proceeds to block 904, where the apparatus may identify another navigational feature that is represented in the image. If the apparatus determines that the image fails to include another navigational feature, flow proceeds to block 902, where the apparatus captures another image.

Even though the example of FIG. 9 illustrates the sending of information indicative of each navigational feature separately, in some embodiments, the apparatus may send information indicative of multiple navigational features together. For example, there may be a single communication that comprises information indicative of more than one navigational feature.

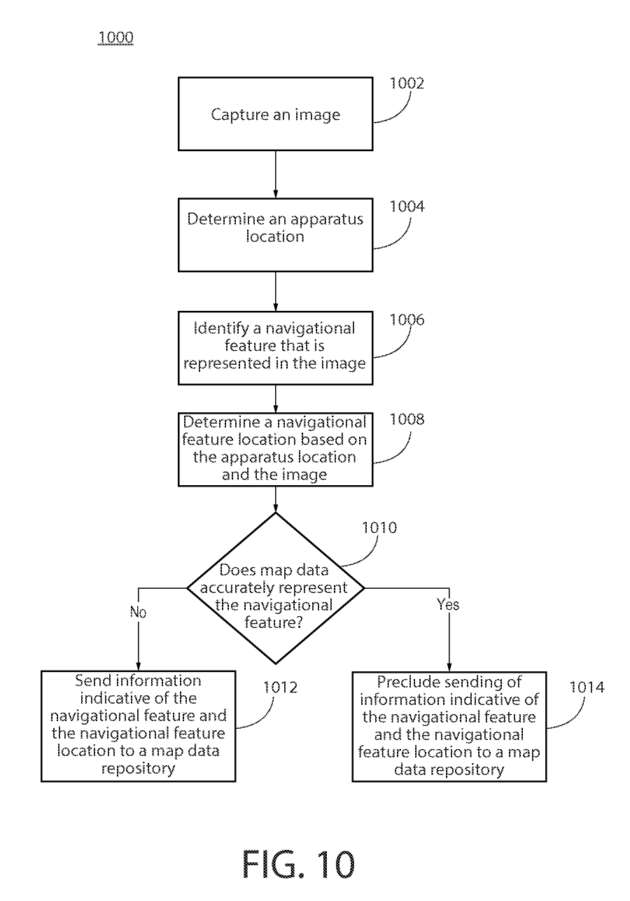

FIG. 10 is a flow diagram illustrating activities 1000 associated with identification of a navigational feature according to at least one example embodiment. In at least one example embodiment, there is a set of operations that corresponds with the activities of FIG. 10. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform the set of operations of FIG. 10.

It may be further desirable to even limit the amount of navigational feature data that the host vehicle sensor apparatus sends to the map data repository. For example, it may be desirable to avoid repeatedly sending navigational feature data that merely substantiates the navigational feature data that is already stored by the map data repository. In this manner, it may be desirable for the host vehicle sensor apparatus to limit the navigational feature data that is sent to the map data repository to be merely navigational feature data that indicates navigational feature data that differs from navigational feature data comprised by the map data repository. Therefore, it may be desirable for the apparatus to have a copy of, at least a portion of, map data that corresponds with the map data stored on the map data repository. Therefore, the apparatus may store a copy of map data repository map data to use for comparison. The apparatus may receive the copy of the map data from a map data repository.

At block 1002, the apparatus captures at least one image, similarly as described regarding block 602 of FIG. 6. At block 1004, the apparatus identifies at least one navigational feature that is represented in the image, similarly as described regarding block 604 of FIG. 6. At block 1006, the apparatus identifies at least one navigational feature that is represented in the image, similarly as described regarding block 604 of FIG. 6. At block 1008, the apparatus determines a navigational feature location based, at least in part, on the apparatus location and the image, similarly as described regarding block 808 of FIG. 8.

At block 1010, the apparatus determines whether the map data accurately represents the navigational feature. If the apparatus determines that the map data fails to accurately represent the navigations feature, flow proceeds to block 1012. If the apparatus determines that the map data accurately represents the navigational feature, flow proceeds to block 1014.

In at least one example embodiment, the determination that the map data fails to accurately represent the navigational feature comprises determination that the navigational feature is absent from the map data. For example, the apparatus may determine that the navigational feature fails to be represented in the map data at all. In at least one example embodiment, the determination that the map data fails to accurately represent the navigational feature comprises determination that the navigational feature is indicated by the map data and that the navigation feature location differs from a navigational feature location indicated by the map data. For example, the navigational feature may be indicated in the map data, but may have moved to a different location since the map data was last updated. In such an example, the apparatus may determine that the navigational feature location determined by the apparatus differs from the navigational feature location indicated by the map data. In at least one example embodiment, the determination that the map data fails to accurately represent the navigational feature comprises determination that the navigational feature and the navigational feature location correspond with the map data, and that supplemental map data associated with the navigational feature differs from supplemental map data that is indicated by the map data. For example, the navigational feature may be a speed limit sign, and the speed limit may have changed since the map data of the map data repository was updated. In this manner, the apparatus may determine that, even though the speed limit sign and the location are accurately represented in the map data, the speed limit is not accurately represented in the map data.

At block 1012, the apparatus sends information indicative of the navigational feature and information indicative of the navigational feature location to a map data repository, similarly as described regarding block 810 of FIG. 8. In this manner, the sending may be performed in response to the determination that the map data fails to accurately represent the navigational feature.

At block 1014, the apparatus precludes sending of information indicative of the navigational feature to the map data repository. For example, the apparatus may avoid performing any instructions that may cause the sending to occur, may delete the navigational feature, and/or the like. In this manner, the apparatus may preclude sending the navigational feature based, at least in part, on the determination that the map data accurately represents the other navigational feature.

As previously described, it may be desirable for the apparatus to utilize a more precise location than what is normally acceptable for mere navigation. With respect to the sensor equipment described in FIGS. 3A-3C, this was accomplished by way of a specialized GPS antenna. However, it may be desirable to avoid having the expense and volume increase associated with such a specialized antenna. Thus, in at least one example embodiment, the apparatus determines an enhanced apparatus location by way of correlating the apparatus location with identified navigational features that are accurately represented in the map data with the navigational feature locations that are represented in the map data. For example, the apparatus may determine a deviation from the calculated navigational feature locations to the navigational feature location that is indicated by the map data, and may apply the deviation to the determined apparatus location to determine an enhanced apparatus location. In at least one example embodiment, the enhanced apparatus location has a greater precision than the apparatus location. In at least one example embodiment, the apparatus determines an enhanced apparatus location based, at least in part, on the apparatus location, the navigational feature location, and a navigational feature location indicated by the map data. In at least one example embodiment, the determination of the enhanced apparatus location is performed in response to the determination that the map data accurately represents a navigational feature. In this manner, the apparatus may derive a benefit from navigational features that are accurately represented in the map data, even though the apparatus may fail to send information indicative of such navigational features to the map data repository.

One or more example embodiments may be implemented in software, hardware, application logic or a combination of software, hardware, and application logic. The software, application logic, and/or hardware may reside on the apparatus, a separate device, or a plurality of separate devices. If desired, part of the software, application logic, and/or hardware may reside on the apparatus, part of the software, application logic and/or hardware may reside on a separate device, and part of the software, application logic, and/or hardware may reside on a plurality of separate devices. In an example embodiment, the application logic, software or an instruction set is maintained on any one of various computer-readable media.

If desired, the different functions discussed herein may be performed in a different order and/or concurrently with each other. For example, block 1006 of FIG. 10 may be performed after block 1008 of FIG. 10. Furthermore, if desired, one or more of the above-described functions may be optional or may be combined. For example, block 1004 of FIG. 10 may be optional and/or combined with block 1008 of FIG. 10.

Although various aspects of the present subject matter are set out in the independent claims, other aspects of the present subject matter comprise other combinations of features from the described example embodiments and/or the dependent claims with the features of the independent claims, and not solely the combinations explicitly set out in the claims.

It is also noted herein that while the above describes example embodiments, these descriptions should not be viewed in a limiting sense. Rather, there are variations and modifications which may be made without departing from the scope of the present subject matter.

What is claimed is:

1. An apparatus, comprising:
a housing;
at least one processor that is contained within the housing;
at least one camera module that is contained within the housing and communicatively coupled with the at least one processor, the housing comprising at least one aperture through which the camera module is configured to capture visual information;
at least one communication device that is contained within the housing and communicatively coupled with the at least one processor;
at least one memory that includes computer program code comprising instructions that, when executed by the at least one processor, cause the apparatus to:
capture at least one image by way of the camera module;
identify at least one navigational feature that is represented in the image; and
send, by way of the communication device, information indicative of the navigational feature to a map data repository.

2. The apparatus of claim 1, wherein the housing comprises at least one magnet that is configured to affix the housing to an automobile.

3. The apparatus of claim 1, wherein the housing has a volume that is less than or substantially equal to 1.125 cubic feet.

4. The apparatus of claim 1, wherein the apparatus fails to comprise any output device.

5. The apparatus of claim 1, wherein the apparatus fails to comprise any user input device.

6. The apparatus of claim 1, wherein the computer program code fails to comprise instructions that require a user input.

7. The apparatus of claim 1, wherein the computer program code further comprises instructions that cause the apparatus to delete the image subsequent to the identification of the navigational feature.

8. The apparatus of claim 1, wherein the identification of the navigational feature comprises:
identifying of a portion of the image to be a representation of a road sign;
recognizing a subportion of the portion of the image to be a representation of road sign information; and
performing pattern recognition on the subportion to determine road sign conveyance data.

9. The apparatus of claim 1, wherein the computer program code further comprises instructions that cause the apparatus to determine that map data fails to accurately represent the navigational feature, wherein the sending of the information indicative of the navigational feature is performed in response to the determination that the map data fails to accurately represent the navigational feature.

10. A method comprising:
capturing at least one image by way of a camera module;
identifying at least one navigational feature that is represented in the image; and
sending, by way of a communication device, information indicative of the navigational feature to a map data repository.

11. The method of claim 10, further comprising deleting the image subsequent to the identification of the navigational feature.

12. The method of claim 10, wherein the identification of the navigational feature comprises:
identifying of a portion of the image to be a representation of a road sign;
recognizing a subportion of the portion of the image to be a representation of road sign information; and
performing pattern recognition on the subportion to determine road sign conveyance data.

13. The method of claim 10, further comprising:
determining an apparatus location;
determining a navigational feature location based, at least in part, on the apparatus location and the image; and
sending, by way of the communication device, information indicative of the navigational feature location to the map data repository.

14. The method of claim 13, further comprising determining that map data fails to accurately represent the navigational feature, wherein the sending of the information indicative of the navigational feature is performed in response to the determination that the map data fails to accurately represent the navigational feature.

15. The method of claim 14, further comprising:
identifying at least one other navigational feature that is represented in the image;
determining another navigational feature location based, at least in part, on the apparatus location and the image, the other navigational feature location being a location of the other navigational feature;
determining that the map data accurately represents the other navigational feature; and
precluding sending, to the map data repository, information indicative of the other navigational feature based, at least in part, on the determination that the map data accurately represents the other navigational feature.

16. The method of claim 15, further comprising determining an enhanced apparatus location based, at least in part, on the apparatus location, the navigational feature location, and a navigational feature location indicated by the map data.

17. At least one computer-readable medium encoded with instructions that, when executed by a processor perform:
capturing at least one image by way of a camera module;
identifying at least one navigational feature that is represented in the image; and
sending, by way of a communication device, information indicative of the navigational feature to a map data repository.

18. The medium of claim 17, wherein the medium is further encoded with instructions that, when executed by a processor perform:
determining an apparatus location;
determining a navigational feature location based, at least in part, on the apparatus location and the image; and
sending, by way of the communication device, information indicative of the navigational feature location to the map data repository.

19. The medium of claim 18, wherein the medium is further encoded with instructions that, when executed by a processor perform determining that map data fails to accurately represent the navigational feature, wherein the sending of the information indicative of the navigational feature is performed in response to the determination that the map data fails to accurately represent the navigational feature.

20. The medium of claim 19, wherein the medium is further encoded with instructions that, when executed by a processor perform:
identifying at least one other navigational feature that is represented in the image;
determining another navigational feature location based, at least in part, on the apparatus location and the image, the other navigational feature location being a location of the other navigational feature;
determining that the map data accurately represents the other navigational feature; and
precluding sending, to the map data repository, information indicative of the other navigational feature based, at least in part, on the determination that the map data accurately represents the other navigational feature.
